(19) United States
(12) Patent Application Publication
(10) Pub. No.: US 2026/0216908 A1
(43) Pub. Date: Jul. 30, 2026

(54) ATTACHMENT DEVICE, KIT COMPRISING A HANDHELD POWER TOOL AND AN ATTACHEMENT DEVICE, AND HANDHELD POWER TOOL

(71) Applicant: HUSQVARNA AB, Huskvarna (SE)

(72) Inventors: Andreas JONSSON, Huskvarna (SE); Anna KINDLUNDH, Huskvarna (SE); Eric HERMANSSON, Huskvarna (SE)

(21) Appl. No.: 19/152,218

(22) PCT Filed: Dec. 28, 2023
(86) PCT No.: PCT/SE2023/051313

§ 371 Date: Jul. 30, 2025

(30) Foreign Application Priority Data
Jan. 30, 2023 (SE) 2350082-0

(51) Int. Cl. B27B 17/00; A45F 5/02; B27B 17/02

(52) U.S. Cl. CPC B27B 17/0008; A45F 5/021; B27B 17/02

(57) ABSTRACT

An attachment device (10) is disclosed comprising a device body (3) comprising a fastening section (5) configured to be fastened against an elongated portion (33′) of the handheld power tool (40) such that a predetermined direction (pd) of the device (10) coincides with a direction of elongation (de) of the elongated portion (33′), and an attachment loop (1) pivotally arranged on the device body (3) around a first pivot axis (ax1) between a storage position and use position. The angle (a1) between the first pivot axis (ax1) and the predetermined direction (pd) is within the range of 70-110 degrees or is within the range of 80-100 degrees. The present disclosure further relates to a kit (20) comprising a handheld power tool (40) and an attachment device (10) as well as a handheld power tool (40) comprising an attachment device (10).

### TECHNICAL FIELD

The present disclosure relates to an attachment device configured to be fastened to a handheld power tool for facilitating attachment of the handheld power tool to a user worn appliance. The present disclosure further relates to a kit comprising a handheld power tool and an attachment device as well as a handheld power tool comprising an attachment device.

### BACKGROUND

A handheld power tool is a tool intended to be supported by one or two hands of a user during operation. Moreover, a handheld power tool comprises a tool which can be driven by a power source other than solely manual labour. The power source may for example comprise a combustion engine, an electric motor, a pneumatic motor, or the like. Examples of handheld power tools are chain saws, jigsaws, trimmers, brush-cutters, and the like. Power tools are for example used in industry, in construction, in gardens, for housework tasks, and around houses for purposes of cutting, shaping, sanding, grinding, routing, polishing, and the like.

On certain occasions, power tools can be used high up in a tree or when standing on a ladder. When climbing such objects, it is an advantage if the user has both hands available. Moreover, when located high up, the user may want to get one or both free when performing certain tasks. However, many handheld power tools lack proper solutions of how to temporarily attach the handheld power tool to the user.

Therefore, some users, such as arborists, find their own ways of going around the problem to be able to hang the handheld power tool in a hook on a user worn appliance, such as a belt or harness. Moreover, for safety reasons, it is an advantage if the handheld power tool is permanently secured to the user via a lanyard, or the like, when a handheld power tool is used at high locations, such that the handheld power tool does not fall from the user if the user drops the handheld power tool.

Some users, such as arborists, commonly utilize a ring of such a lanyard, or a ring attached at a portion of the handheld power tool, when temporarily attaching the handheld power tool to a hook of the user worn appliance. However, in most cases, the ring of the lanyard is not fixed to the handheld power tool and a ring of the handheld power tool is usually not adapted to be used for hanging the handheld power tool to a hook. For these reasons, the process of hanging the handheld power tool to the hook of the user worn appliance is usually burdensome, time consuming, and usually requires both hands of the user. Likewise, the process of removing the ring from the hook, for detaching the handheld power tool from the user worn appliance, is usually burdensome, time consuming, and usually requires both hands of the user.

The use of two hands for attaching/detaching the handheld power tool to/from the user worn appliance may cause safety concerns when the user is located high up, for example in a tree or on a ladder. Furthermore, generally, self-made solutions can cause safety concerns and are usually not reliable and user-friendly.

Moreover, many users, such as arborists, frequently need to attach/detach the handheld power tool to/from the user worn appliance during a work session. Therefore, it is a great advantage if the process of attaching/detaching the handheld power tool to/from the user worn appliance can be made in a safer and more efficient manner.

Furthermore, generally, it is an advantage if products, such as handheld power tools and associated components and arrangements, have conditions and/or characteristics suitable for being manufactured and assembled in a cost-efficient manner.

### SUMMARY

It is an object of the present invention to overcome, or at least alleviate, at least some of the above-mentioned problems and drawbacks.

According to a first aspect of the invention, the object is achieved by an attachment device configured to be fastened to a handheld power tool for facilitating attachment of the handheld power tool to a user worn appliance, wherein the attachment device comprises a device body comprising a fastening section configured to be fastened against an elongated portion of the handheld power tool such that a predetermined direction of the attachment device coincides with a direction of elongation of the elongated portion of the handheld power tool, and an attachment loop pivotally arranged on the device body around a first pivot axis between a storage position and use position. The angle between the first pivot axis and the predetermined direction is within the range of 70-110 degrees or is within the range of 80-100 degrees.

Thereby, an attachment device is provided significantly facilitating the process of attaching the handheld power tool to a hook of a user worn appliance. This is because the angle between the first pivot axis and the predetermined direction is within one of the above specified ranges and because the fastening section is configured to be fastened against an elongated portion of the handheld power tool such that the predetermined direction of the attachment device coincides with the direction of elongation of the elongated portion of the handheld power tool. That is, due to these features, a user is allowed to attach the handheld power tool to a user worn appliance comprising a hook in a quick, simple, and convenient manner by threading the attachment loop over the hook, for example using one hand only.

Moreover, due to the features of the attachment device, it can be ensured that the handheld power tool hangs in a predetermined, safe, and convenient orientation relative to the user when a handheld power tool is attached to a user worn appliance using the attachment device. This is because the angle between the first pivot axis and the predetermined direction is within one of the above specified ranges and because the fastening section is configured to be fastened against an elongated portion of the handheld power tool such that the predetermined direction of the attachment device coincides with the direction of elongation of the elongated portion of the handheld power tool.

In addition, due to the features of the attachment device, a user is allowed to detach the handheld power tool from the hook of the user worn appliance in a quick, simple, and convenient manner, for example using one hand only.

Furthermore, since the attachment loop is pivotally arranged on the device body between the storage position and the use position, a user-friendly attachment device is provided allowing a user to pivot the attachment loop to the use position when the attachment device is fastened to a handheld power tool and the attachment loop is to be used to attach the handheld power tool to a hook of a user worn appliance. Moreover, the user may pivot the attachment loop to the storage position when the attachment device is fastened to a handheld power tool but the attachment loop is not to be used to attach the handheld power tool to a hook of a user worn appliance. As a further result, the safety of handling of the handheld power tool can be improved because the attachment loop may be less likely to become stuck to objects, such as tree branches and the like when the attachment loop is in the storage position.

Accordingly, an attachment device is provided overcoming, or at least alleviating, at least some of the above-mentioned problems and drawbacks. As a result, the above-mentioned object is achieved.

Optionally, the attachment device comprises a fastening member arranged on the device body, and wherein the fastening section and the fastening member together are configured to enclose the elongated portion of the handheld power tool. Thereby, it can be further ensured that the attachment device is securely fastened to the elongated portion of the handheld power tool.

Optionally, a first end of the fastening member is pivotally arranged on the device body, and wherein a second end of the fastening member is configured to be attached to the device body using a fastening element. Thereby, a user-friendly attachment device is provided having conditions for being fastened to an elongated portion of the handheld power tool, in a quick, simple, and safe manner. This is because a user may pivot the fastening member to a position allowing the fastening section to be placed against the elongated portion of the handheld power tool. Then, the user may pivot the fastening member in an opposite pivoting direction to a position in which the second end of the fastening member can be attached to the device body using the fastening element.

Moreover, due to these features, an attachment device is provided having conditions for fastening the attachment device to the elongated portion of the handheld power tool in a safe and secure manner using one fastening element only.

Optionally, the fastening section and the fastening member together are configured to enclose the elongated portion of the handheld power tool in a plane perpendicular to the direction of elongation of the elongated portion of the handheld power tool. Thereby, it can be further ensured that the attachment device can be fastened to the elongated portion of the handheld power tool in a secure and rigid manner.

Optionally, the fastening section and the fastening member are configured to apply clamping forces onto the elongated portion of the handheld power tool in directions substantially perpendicular to the direction of elongation of the elongated portion of the handheld power tool. Thereby, it can be further ensured that the attachment device can be fastened to the elongated portion of the handheld power tool in a secure and rigid manner.

Optionally, the attachment device comprises a locking arrangement configured to lock the attachment loop from pivoting from the storage position when the attachment loop is in the storage position and the locking arrangement is in a locking state. Thereby, an even more user-friendly attachment device is provided. Moreover, the safety of handling of the handheld power tool can be improved because the attachment loop may be less likely to become stuck to an object, such as a branch or the like when the attachment loop is locked from pivoting from the storage position by the locking arrangement.

Optionally, the locking arrangement is configured to assume a locking state when the attachment loop is pivoted to the storage position. Thereby, an even more user-friendly attachment device is provided. This is because the locking arrangement can be caused to assume the locking state, in which the locking arrangement locks the attachment loop from pivoting from the storage position, simply by pivoting the attachment loop to the storage position.

Optionally, the attachment device comprises a locking arrangement configured to lock the attachment loop from pivoting from the use position when the attachment loop is in the use position and the locking arrangement is in a locking state. Thereby, an even more user-friendly attachment device is provided capable of further ensuring that the user is allowed to attach the handheld power tool to a user worn appliance comprising a hook in a quick, simple, and convenient manner by threading the attachment loop over the hook.

Moreover, it can be further ensured that the handheld power tool hangs from the user worn appliance handheld in a predetermined, safe, and convenient orientation relative to the user when a handheld power tool is attached to a user worn appliance using the attachment device.

Optionally, the locking arrangement is configured to assume a locking state when the attachment loop is pivoted to the use position. Thereby, an even more user-friendly attachment device is provided. This is because the locking arrangement can be caused to assume the locking state, in which the locking arrangement locks the attachment loop from pivoting from the use position, simply by pivoting the attachment loop to the use position.

Optionally, a portion of the attachment loop forms part of the locking arrangement. Thereby, conditions are provided for a compact attachment device having a low degree of complexity while being capable of preventing unintentional pivoting of the attachment loop relative to the device body. Moreover, an attachment device is provided having conditions and characteristics suitable for being manufactured and assembled in a cost-efficient manner.

Optionally, the locking arrangement comprises a protrusion arranged on the device body, and wherein the locking arrangement is configured to lock the attachment loop from pivoting around the first pivot axis by an abutting contact between a portion of the attachment loop and the protrusion when the locking arrangement is in a locking state. Thereby, conditions are provided for a compact attachment device having a low degree of complexity while being capable of preventing unintentional pivoting of the attachment loop relative to the device body in a simple and secure manner. Moreover, an attachment device is provided having conditions and characteristics suitable for being manufactured and assembled in a cost-efficient manner.

Optionally, the portion of the attachment loop is configured to move along a first direction at least substantially coinciding with the first pivot axis when the locking arrangement is transferred from a locking state to an unlocking state. Thereby, the locking arrangement of the attachment device can be transferred between locking states and unlocking states in a simple, reliable, and intuitive manner. Moreover, conditions are provided for a compact attachment device having a low degree of complexity while being capable of preventing unintentional pivoting of the attachment loop relative to the device body. In addition, an attachment device is provided having conditions and characteristics suitable for being manufactured and assembled in a cost-efficient manner.

Optionally, the attachment device comprises a resilient element configured to bias the portion of the attachment loop in a second direction being opposite to the first direction. Thereby, a simple and reliable solution is provided for further ensuring that the locking arrangement remains in a locking state and thus also that the attachment loop is securely retained in one of the storage and use positions.

Optionally, the locking arrangement is configured to be transferred from a locking state to an unlocking state by elastic deformation of the attachment loop. Thereby, the locking arrangement of the attachment device can be transferred from a locking state to an unlocking state in a simple, reliable, and intuitive manner. Moreover, conditions are provided for a compact attachment device having a low degree of complexity while being capable of preventing unintentional pivoting of the attachment loop relative to the device body. In addition, an attachment device is provided having conditions and characteristics suitable for being manufactured and assembled in a cost-efficient manner.

Optionally, the attachment loop is formed by a polymeric material. Thereby, conditions are provided for a strong and lightweighted attachment loop allowing a quick, simple, and convenient attachment of the handheld power tool to a hook of a user worn appliance. Moreover, conditions are provided for an attachment loop having certain dimensions while allowing a user to elastically deform the attachment loop to transfer the locking arrangement from a locking state to an unlocking state.

Optionally, the smallest diameter of the attachment loop is greater than 5 mm. Thereby, conditions are provided for a strong and lightweighted attachment loop allowing a quick, simple, and convenient attachment of the handheld power tool to a hook of a user worn appliance.

Optionally, the attachment device comprises a second loop pivotally arranged on the device body around a second pivot axis between a storage position and at least one use position. Thereby, an attachment device is provided capable of further improving the safety of handling of a handheld power tool. This is because the second loop can be used for further securing the handheld power tool to the user worn appliance using a lanyard, a cord, a rope, or the like, extending between the second loop and the user worn appliance. In this manner, it can be further ensured that a user does not lose control of the handheld power tool and that the handheld power tool falls from the user, for example when the user is located high up in a tree, on a ladder, or the like.

Moreover, since the second loop is pivotally arranged on the device body between the storage position and the at least one use position, a user-friendly attachment device is provided allowing a user to pivot the second loop to a use position when the attachment device is fastened to a handheld power tool and the second loop is to be used to secure the handheld power tool to a user worn appliance using a lanyard, a cord, a rope, or the like. Moreover, the user is allowed to pivot the second loop to the storage position when the attachment device is fastened to a handheld power tool but the second loop is not to be used to secure the handheld power tool to a user worn appliance. As a further result, the safety of handling of the handheld power tool can be improved because the second loop may be less likely to become stuck to an object, such as a branch or the like, when the second loop is in the storage position.

Optionally, the second pivot axis is transversal to the first pivot axis. Thereby, conditions are provided for a compact attachment device capable of attaching the handheld power tool to a user worn appliance comprising a hook in a quick, simple, and convenient manner by use of the attachment loop on the hook of the user worn appliance and capable of further securing the handheld power tool to the user worn appliance by use of a lanyard, a cord, a rope, or the like, extending between the second loop and the user worn appliance.

Optionally, the angle between the first and second pivot axes is within the range of 20-160 degrees, or is within the range of 80-100 degrees. Thereby, conditions are provided for a compact attachment device capable of attaching the handheld power tool to a user worn appliance comprising a hook in a quick, simple, and convenient manner by use of the attachment loop on the hook of the user worn appliance and capable of further securing the handheld power tool to the user worn appliance by use of a lanyard, a cord, a rope, or the like, extending between the second loop and the user worn appliance.

Optionally, the second loop is formed by a metal material. Thereby, conditions are provided for a strong, durable, and compact second loop.

Optionally, the diameter of the second loop is within the range of 1.5-5 mm or is within the range of 2-4 mm. Thereby, conditions are provided for a strong, durable, and compact second loop.

Optionally, the second loop is pivotally arranged on the device body between the storage position and a first and a second use position. Thereby, an even more user-friendly attachment device is provided. This is because a user may select whether to use the first or second use position of the second loop for example depending on a current application, a current operation task to perform with the handheld power tool, and the like.

Optionally, the angle between the first and second use positions is within the range of 70-110 degrees, or is within the range of 80-100 degrees. Thereby, a user-friendly attachment device is provided allowing the user to select between two substantially different use positions of the second loop.

Optionally, the angle between the storage position and the first use position is within the range of 70-110 degrees, or is within the range of 80-100 degrees. Thereby, conditions are provided for a compact attachment device when the second loop is in the storage position. Moreover, conditions are provided for a simple attachment of a lanyard, a cord, a rope, or the like, when the second loop is in the first use position.

Optionally, the attachment device comprises a snap fit assembly configured to releasably retain the second loop in the storage position and the at least one use position. Thereby, an even more user-friendly attachment device is provided. This is because unintended pivoting of the second loop can be avoided. In other words, it can be ensured that the second loop remains in the storage position when the second loop is not to be used to further secure a handheld power tool to a user worn appliance and it can be ensured that the second loop remains in the at least one use position when the second loop is, or is to be, used for further securing a handheld power tool to a user worn appliance. Moreover, since the snap fit assembly is configured to releasably retain the second loop in the at least one use position, the process of attaching a lanyard, a cord, a rope, or the like, to the second loop may be facilitated.

Optionally, the snap fit assembly is formed by a number of grooves on the device body and a portion of the second loop. Thereby, conditions are provided for a simple, efficient, and reliable retention of the second loop in the storage position and in the at least one use position. Moreover, conditions are provided for a compact attachment device capable of releasably retaining the second loop in the storage position and the at least one use position. In addition, an attachment device is provided having conditions and characteristics suitable for being manufactured and assembled in a cost-efficient manner.

According to a second aspect of the invention, the object is achieved by a kit comprising a handheld power tool and an attachment device according to some embodiments of the present disclosure, wherein the attachment device is attachable to an elongated portion of the handheld power tool such that a predetermined direction of the attachment device coincides with a direction of elongation of the elongated portion of the handheld power tool.

Thereby, a kit is provided significantly facilitating the process of attaching the handheld power tool to a hook of a user worn appliance. This is because the angle between the first pivot axis and the predetermined direction of the attachment device is within one of the above specified ranges and because the fastening section is configured to be fastened against the elongated portion of the handheld power tool such that the predetermined direction of the attachment device coincides with the direction of elongation of the elongated portion of the handheld power tool. That is, due to these features, a user is allowed to attach the handheld power tool to a user worn appliance comprising a hook in a quick, simple, and convenient manner by threading the attachment loop of the attachment device over the hook, for example using one hand only.

Moreover, due to the features of the kit, it can be ensured that the handheld power tool hangs in a predetermined, safe, and convenient orientation relative to the user when a handheld power tool is attached to a user worn appliance using the attachment device. This is because the angle between the first pivot axis and the predetermined direction of the attachment device is within one of the above specified ranges and because the fastening section is configured to be fastened against the elongated portion of the handheld power tool such that the predetermined direction of the attachment device coincides with the direction of elongation of the elongated portion of the handheld power tool.

In addition, due to the features of the kit, a user is allowed to detach the handheld power tool from the hook of the user worn appliance in a quick, simple, and convenient manner, for example using one hand only.

Furthermore, since the attachment loop of the attachment device is pivotally arranged on the device body between the storage position and the use position, a user-friendly kit is provided allowing a user to pivot the attachment loop to the use position when the attachment device is fastened to the handheld power tool and the attachment loop is to be used to attach the handheld power tool to a hook of a user worn appliance. Moreover, the user is allowed to pivot the attachment loop to the storage position when the attachment device is fastened to the handheld power tool but the attachment loop is not to be used to attach the handheld power tool to a hook of a user worn appliance. As a further result, the safety of handling of the handheld power tool can be improved because the attachment loop may be less likely to become stuck to objects, such as tree branches and the like when the attachment loop is in the storage position.

Accordingly, a kit is provided overcoming, or at least alleviating, at least some of the above-mentioned problems and drawbacks. As a result, the above-mentioned object is achieved.

The kit, as referred to herein, may also be referred to as “a power tool kit”. According to some embodiments, the kit comprises a user worn appliance, wherein the user worn appliance comprises a belt or a harness provided with a hook, and wherein the attachment loop is attachable to the hook when the attachment loop is in the use position.

Optionally, the elongated portion of the handheld power tool is a handle portion of the handheld power tool. Thereby, it can be further ensured that the user is allowed to attach the handheld power tool to a user worn appliance comprising a hook in a quick, simple, and convenient manner by threading the attachment loop of the attachment device over the hook.

Moreover, it can be ensured that the handheld power tool hangs in a predetermined, safe, and convenient orientation relative to the user when a handheld power tool is attached to a user worn appliance using the attachment device.

Optionally, the attachment loop is loop-shaped in an extension plane of the attachment loop, and wherein the angle between the extension plane of the attachment loop and a bottom plane of the handheld power tool is within the range of 0 -60 degrees, or is within the range of 15-45 degrees, when the attachment loop is in the use position and the attachment device is attached to the elongated portion of the handheld power tool such that the predetermined direction of the attachment device coincides with the direction of elongation of the elongated portion of the handheld power tool. Thereby, it can be ensured that the handheld power tool hangs in a safe and convenient orientation from a hook of a user worn appliance when the attachment loop of the attachment device is threaded over the hook. Moreover, it can be further ensured that the user is allowed to attach the handheld power tool to a user worn appliance comprising a hook in a quick, simple, and convenient manner by threading the attachment loop of the attachment device over the hook.

Optionally, the handheld power tool is a chainsaw or a hedge trimmer. Thereby, a chainsaw or hedge trimmer is provided having at least some of the above-mentioned advantages.

According to a third aspect of the invention, the object is achieved by a handheld power tool comprising an attachment device according to some embodiments of the present disclosure, wherein the attachment device is attached to an elongated portion of the handheld power tool such that a predetermined direction of the attachment device coincides with a direction of elongation of the elongated portion of the handheld power tool.

Thereby, a handheld power tool is provided significantly facilitating the process of attaching the handheld power tool to a hook of a user worn appliance. This is because the angle between the first pivot axis and the predetermined direction of the attachment device is within one of the above specified ranges and because the fastening section is configured to be fastened against the elongated portion of the handheld power tool such that the predetermined direction of the attachment device coincides with the direction of elongation of the elongated portion of the handheld power tool. That is, due to these features, a user is allowed to attach the handheld power tool to a user worn appliance comprising a hook in a quick, simple, and convenient manner by threading the attachment loop of the attachment device over the hook, for example using one hand only.

Moreover, due to the features of the handheld power tool, it can be ensured that the handheld power tool hangs in a predetermined, safe, and convenient orientation relative to the user when a handheld power tool is attached to a user worn appliance using the attachment device. This is because the angle between the first pivot axis and the predetermined direction of the attachment device is within one of the above specified ranges and because the fastening section is configured to be fastened against the elongated portion of the handheld power tool such that the predetermined direction of the attachment device coincides with the direction of elongation of the elongated portion of the handheld power tool.

In addition, due to the features of the handheld power tool, a user is allowed to detach the handheld power tool from the hook of the user worn appliance in a quick, simple, and convenient manner, for example using one hand only.

Furthermore, since the attachment loop of the attachment device is pivotally arranged on the device body between the storage position and the use position, a user-friendly handheld power tool is provided allowing a user to pivot the attachment loop to the use position when the attachment loop is to be used to attach the handheld power tool to a hook of a user worn appliance. Moreover, the user is allowed to pivot the attachment loop to the storage position when the attachment loop is not to be used to attach the handheld power tool to a hook of a user worn appliance. As a further result, the safety of handling of the handheld power tool can be improved because the attachment loop may be less likely to become stuck to objects, such as tree branches and the like when the attachment loop is in the storage position.

Accordingly, a handheld power tool is provided overcoming, or at least alleviating, at least some of the above-mentioned problems and drawbacks. As a result, the above-mentioned object is achieved.

Further features of, and advantages with, the present invention will become apparent when studying the appended claims and the following detailed description.

### BRIEF DESCRIPTION OF THE DRAWINGS

Various aspects of the invention, including its particular features and advantages, will be readily understood from the example embodiments discussed in the following detailed description and the accompanying drawings, in which:

FIG. 1 illustrates a side view of a handheld power tool according to some embodiments of the present disclosure,

FIG. 2 illustrates a first enlarged view of a handle assembly of the handheld power tool illustrated in FIG. 1, wherein an attachment device according to some embodiments is fastened against an elongated portion of the handle assembly,

FIG. 3 illustrates the attachment device according to the embodiments illustrated in FIG. 2 as seen in a direction straight towards a fastening section thereof,

FIG. 4 illustrates a second enlarged view of the handle assembly of the handheld power tool illustrated in FIG. 1,

FIG. 5 illustrates a first front view of the attachment device illustrated in FIG. 3,

FIG. 6a illustrates a perspective view of the attachment device illustrated in FIG. 5,

FIG. 6b illustrates the perspective view of the attachment device illustrated in FIG. 6b in which an attachment loop of the attachment device has been pivoted around a first pivot axis to a use position,

FIG. 7a illustrates a second front view of the attachment device illustrated in FIG. 3,

FIG. 7b illustrates the attachment device illustrated in FIG. 7a in which a second loop of the attachment device has been pivoted to a first use position,

FIG. 7c illustrates the attachment device illustrated in FIG. 7b in which the second loop has been pivoted to a second use position,

FIG. 7d illustrates the attachment device illustrated in FIG. 7c in which the attachment loop has been pivoted to a storage position,

FIG. 8a illustrates a top view of the attachment device illustrated in FIG. 7a,

FIG. 8b illustrates the top view of the attachment device illustrated in 8a in which the second loop has been pivoted to the first use position,

FIG. 8c illustrates the top view of the attachment device illustrated in 8b in which the second loop has been pivoted to the second use position, and

FIG. 9 illustrates a handheld power tool according to the embodiments illustrated in FIG. 1, wherein the handheld power tool is attached to a user worn appliance using an attachment device as explained with reference to FIG. 2-FIG. 8c.

### DETAILED DESCRIPTION

Aspects of the present invention will now be described more fully. Like reference signs refer to like elements throughout. Well-known functions or constructions will not necessarily be described in detail for brevity and/or clarity.

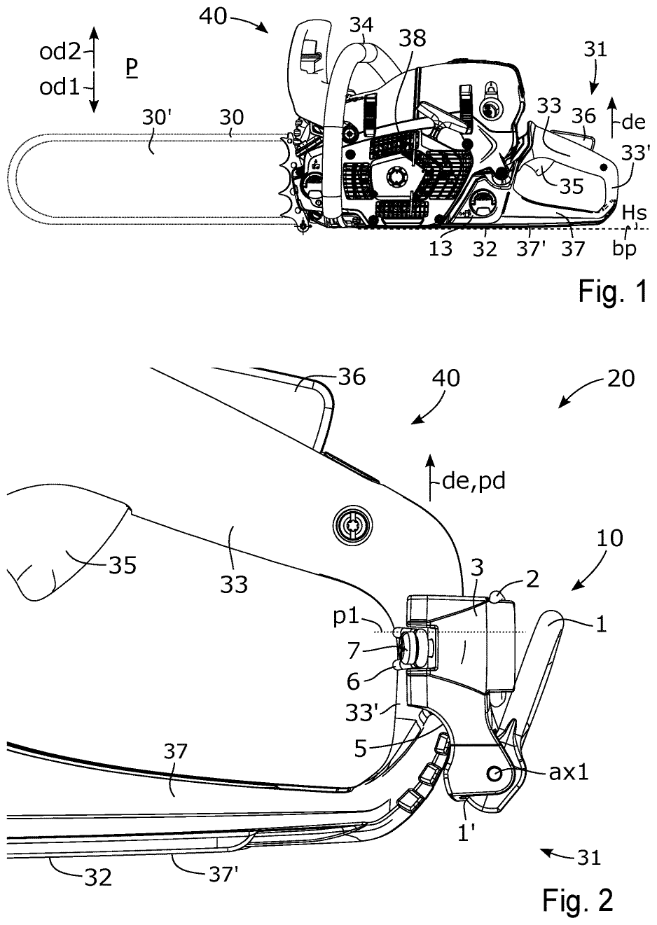

FIG. 1 illustrates a side view of a handheld power tool 40 according to some embodiments of the present disclosure. The handheld power tool 40 comprises a tool 30 and a power source 38 configured to power the tool 30. According to the illustrated embodiments, the handheld power tool 40 is a chainsaw comprising a tool 30 in the form of a cutting chain movably arranged around a guide bar 30′. In FIG. 1, the cutting chain and the guide bar 30′ are schematically illustrated.

The power source 38 is configured to rotate the cutting chain around the guide bar 30′ during operation of the handheld power tool 40. According to further embodiments, the handheld power tool 40, as referred to herein, may be another type of handheld power tool 40 than a chainsaw, such as for example a power cutter, a circular saw, a jigsaw, a hedge trimmer, or the like. Obviously, according to such embodiments, the handheld power tool 40 may comprise another type of tool 30 than a cutting chain, such as for example a saw blade, a hedge trimmer cutting assembly, or the like.

According to the illustrated embodiments, the power source 38 is an internal combustion engine. In more detail, according to the illustrated embodiments, the power source 38 is a small sized two-stroke internal combustion engine. The handheld power tool comprises a fuel tank 13 configured to store fuel which is supplied to the internal combustion engine during operation thereof. The internal combustion engine of the handheld power tool 40 may be configured to run on gasoline, also referred to as petrol, alcohol, similar volatile fuels, or combinations thereof.

According to some further embodiments, the handheld power tool 40 may comprise another type of power source, such as an electric motor. According to such embodiments, the handheld power tool 40 may comprise an electric battery for supplying electricity to the electric motor during operation thereof. As an alternative, or in addition, the handheld power tool 40 may comprise another type of device for supplying electricity to the electric motor during operation thereof, such as a connector for connecting the electric motor to an electric power cord.

The handheld power tool 40 comprises a first handle 33 and a second handle 34. The second handle 34 is separate from the first handle 33 and is arranged at a distance from the first handle 33. The handheld power tool 40 is configured to be supported via each of the first and second handles 33, 34 during operation of the handheld power tool 40. In other words, the handheld power tool 40 is configured to be supported by two hands of a user during operation of the handheld power tool 40, i.e., is configured to be supported by one hand grabbing the first handle 33 and the other hand grabbing the second handle 34.

According to the illustrated embodiments, the first handle 33 is a rear handle arranged at a rear portion of the handheld power tool 40 and the second handle 34 is a so-called front handle. According to the illustrated embodiments, the second handle 34 is arranged closer to the tool 30 of the handheld power tool 40 than the first handle 33. Moreover, the second handle 34 is arranged at a position between the tool 30 of the handheld power tool 40 and the first handle 33 of the handheld power tool 40. According to the illustrated embodiments, the second handle 34 is formed by an elongated curved-shaped body allowing a user to grip the second handle 34 from various directions in a convenient manner. Thereby, a user is allowed to operate the handheld power tool 40 at different orientations relative to the gravitational field in a convenient and safe manner.

The handheld power tool 40 comprises a throttle actuator 35 arranged at the first handle 33. The throttle actuator 35 can be used to control a power output of the power source 38. The handheld power tool 40 further comprises a safety actuator 36 arranged at the first handle 33. The safety actuator 36 is operably connected to a mechanism preventing actuation of the throttle actuator 35 when the safety actuator 36 not is pressed and allowing actuation of the throttle actuator 35 when the safety actuator 36 is pressed. According to the illustrated embodiments, the safety actuator 36 is arranged to be pressed by the palm of a hand of a user whereas the throttle actuator 35 is arranged to be actuated, i.e., pressed, by one or more fingers of the hand of a user.

In FIG. 1, the handheld power tool 40 is illustrated as viewed straight towards a side of the handheld power tool 40. Moreover, in FIG. 1, the handheld power tool 40 is illustrated as positioned in a usual upright parking position on a flat horizontal support surface Hs. When the handheld power tool 40 is positioned in the usual upright parking position on a flat horizontal support surface Hs, a bottom side 32 of the handheld power tool 40 is resting, i.e., is abutting, against the flat horizontal support surface Hs. According to the illustrated embodiments, the second handle 34 is arranged at a distance from the first handle 33 as measured along a direction parallel to the bottom side 32 of the handheld power tool 40.

As mentioned, according to the illustrated embodiments, the handheld power tool 40 is a chainsaw comprising a tool 30 in the form of a cutting chain movably arranged around a guide bar 30′. A cutting chain is a type of cutting tool which is configured to operate in a cutting plane P. In FIG. 1, the cutting plane P is perpendicular to the flat horizontal support surface Hs as well as to the viewing direction of FIG. 1.

Moreover, according to the illustrated embodiments, the tool 30 is arranged to operate in two different primary operational directions od1, od2. Each of the two different primary operational directions od1, od2 coincides with the cutting plane P. According to the illustrated embodiments, the cutting plane P, and each of the two different primary operational directions od1, od2, is substantially perpendicular to the bottom side 32 of the handheld power tool 40, i.e., is substantially perpendicular to a flat horizontal support surface Hs when the handheld power tool 40 is positioned in the usual upright parking position on the flat horizontal support surface Hs. The tool 30 of the handheld power tool 40 may be operable in directions differing from the two different primary operational directions od1, od2. However, each of the two different primary operational directions od1, od2 may constitute an intended operation direction in which the tool 30 operates in an efficient manner.

The first and second handles 33, 34 of the handheld power tool 40 can be accessed in an easy manner when the handheld power tool 40 is positioned in the usual upright parking position on the flat horizontal support surface Hs because the intended grabbing directions of the first and second handles 33, 34 are substantially perpendicular to the flat horizontal support surface Hs when the handheld power tool 40 is positioned in the usual upright parking position on the flat horizontal support surface Hs.

The reason for the use of the word “usual” herein in the expression “usual upright parking position” is that the handheld power tool 40 could possibly be positioned on a flat horizontal support surface Hs in another orientation relative to the flat horizontal support surface Hs, such as for example laid on the side on the flat horizontal support surface Hs. However, if so, the cutting plane P of the tool 30, and each of the least two different primary operational directions od1, od2 of the tool 30, as well as the intended grabbing directions of the first and second handles 33, 34, will not be substantially perpendicular to the flat horizontal support surface Hs. Moreover, if so, the bottom side 32 of the handheld power tool 40 will apparently not rest against the flat horizontal support surface Hs.

The first handle 33 of the handheld power tool 40 forms part of a handle assembly 31 of the handheld power tool 40. In other words, the handheld power tool 40 comprises a handle assembly 31 comprising the first handle 33. The handle assembly 31 may also be referred to as a rear handle assembly of the handheld power tool 40 because the handle assembly 31 is arranged at a rear portion of the handheld power tool 40. The rear portion of the handheld power tool 40 is opposite to a tool portion of the handheld power tool 40. The tool portion of the handheld power tool 40 comprises the tool 30 of the handheld power tool 40.

The handle assembly 31 further comprises a guard portion 37 arranged opposite to the first handle 33. As seen in FIG. 1, the guard portion 37 of the handle assembly 31 is arranged closer to the flat horizontal support surface Hs than the first handle 33 when the handheld power tool 40 is positioned in the usual upright parking position on the flat horizontal support surface Hs. A bottom side 37′of the guard portion 37 may form part of the bottom side 32 of the handheld power tool 40.

The handle assembly 31 of the handheld power tool 40 further comprises an elongated portion 33′ connecting the guard portion 37 and the first handle 33. The elongated portion 33′ of the handheld power tool 40 is thus a handle portion of the handheld power tool 40. In FIG. 1, a direction of elongation de of the elongated portion 33′ is indicated. According to the illustrated embodiments, the direction of elongation de of the elongated portion 33′ is substantially perpendicular to a flat horizontal support surface Hs when the handheld power tool 40 is positioned in the usual upright parking position on the flat horizontal support surface Hs. In other words, according to the illustrated embodiments, the direction of elongation de of the elongated portion 33′ is substantially perpendicular to the bottom side 32 of the handheld power tool 40. Moreover, according to the illustrated embodiments, the direction of elongation de of the elongated portion 33′ is substantially parallel to each of the two different primary operational directions od1, od2 of the tool 30 of the handheld power tool 40.

According to further embodiments, the angle between the direction of elongation de of the elongated portion 33′ and the bottom side 32 of the handheld power tool 40 may be within the range of 45-135 degrees, or may be within the range of 60-120 degrees. As understood from the above described, according to such embodiments, the angle between the direction of elongation de of the elongated portion 33′ and a flat horizontal support surface Hs is within the range of 45-135 degrees, or is within the range of 60-120 degrees, when the handheld power tool 40 is positioned in the usual upright parking position on the flat horizontal support surface Hs.

FIG. 2 illustrates a first enlarged view of the handle assembly 31 of the handheld power tool 40 illustrated in FIG. 1. Moreover, in FIG. 2, the handheld power tool 40 is illustrated as comprising an attachment device 10 fastened against the elongated portion 33′ of the handle assembly 31 of the handheld power tool 40. As is further explained herein, the attachment device 10 is configured to be fastened to a handheld power tool 40 for facilitating attachment of the handheld power tool 40 to a user worn appliance. For reasons of brevity and clarity, the attachment device 10 is in some places herein referred to as “the device 10”.

The attachment device 10 comprises a device body 3 comprising a fastening section 5 configured to be fastened against an elongated portion 33′ of a handheld power tool 40 such that a predetermined direction pd of the attachment device 10 coincides with a direction of elongation de of the elongated portion 33′ of the handheld power tool 40. The direction of elongation de indicated in FIG. 2 is the same direction of elongation de as referred to with reference to FIG. 1 above.

The attachment device 10 further comprises an attachment loop 1. As is further explained herein, the attachment loop 1 is configured to be threaded over a hook of a user worn appliance to attach the handheld power tool 40 to the user worn appliance. The attachment loop 1 is pivotally arranged on the device body 3 around a first pivot axis ax1 between a storage position and use position. In FIG. 2, the attachment loop 1 is illustrated in the storage position. The storage position of the attachment loop 1 can be used when the attachment device 10 is not to be used to attach the handheld power tool 40 to a user worn appliance.

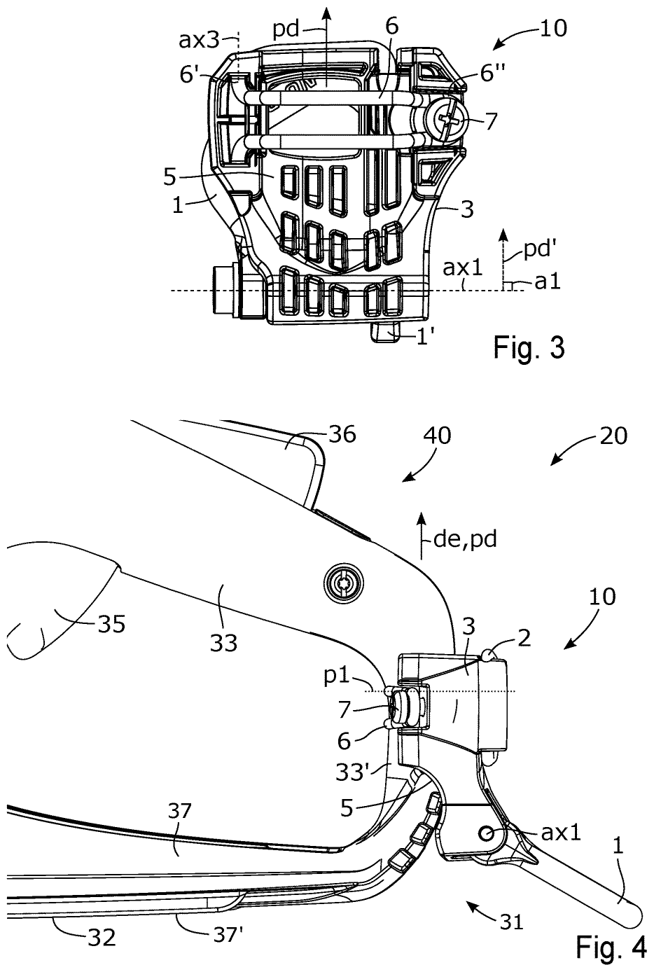

FIG. 3 illustrates an attachment device 10 according to the embodiments illustrated in FIG. 2 as seen in a direction straight towards the fastening section 5 thereof. In FIG. 3, the predetermined direction pd of the attachment device 10 is indicated. Moreover, the first pivot axis ax1 of the attachment loop 1 is indicated.

As indicated in FIG. 3, according to the illustrated embodiments, the angle a1 between the first pivot axis ax1 and the predetermined direction pd is 90 degrees. In other words, according to the illustrated embodiments, the first pivot axis ax1 is perpendicular to the predetermined direction pd. According to further embodiments, the angle a1 between the first pivot axis ax1 and the predetermined direction pd may be within the range of 70-110 degrees or may be within the range of 80-100 degrees.

This provides several advantages including that a user is allowed to fasten a handheld power tool to a user worn appliance comprising a hook in a quick, simple, and convenient manner by threading the attachment loop 1 over the hook, as is further explained herein.

As seen in FIG. 2 and FIG. 3, according to the illustrated embodiments, the attachment device 10 comprises a fastening member 6 arranged on the device body 3. As best seen in FIG. 2, the fastening section 5 and the fastening member 6 together are configured to enclose the elongated portion 33′ of the handheld power tool 40. In more detail, according to the illustrated embodiments, the fastening section 5 and the fastening member 6 together are configured to enclose the elongated portion 33′ of the handheld power tool 40 in a plane p1 being perpendicular to the direction of elongation de of the elongated portion 33′ of the handheld power tool 40 when the attachment device 10 is fastened to the elongated portion 33′ of the handheld power tool 40.

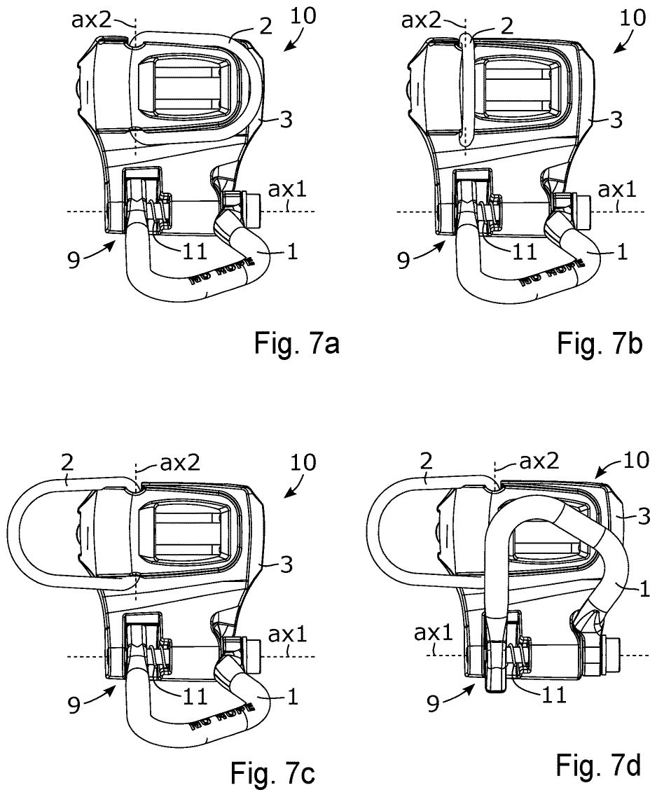

As is indicated in FIG. 3, according to the illustrated embodiments, a first end 6′ of the fastening member 6 is pivotally arranged on the device body 3 around a third pivot axis ax3. A second pivot axis ax2 of the attachment device 10 is explained e.g., with reference to FIG. 7a below. Moreover, as is indicated in FIG. 3, a second end 6″ of the fastening member 6 is configured to be attached to the device body 3 using a fastening element 7. According to the illustrated embodiments, the fastening element 7 is a screw. According to further embodiments, the second end 6″ of the fastening member 6 may be configured to be attached to the device body 3 using another type of fastening element, such as a bolt, a snap fit element, or the like. The fastening element 7 is also indicated in FIG. 2. The fastening element 7 may be comprised in the attachment device 10 according to the embodiments herein.

Due to these features, the attachment device 10 can be attached to the elongated portion 33′ of the handheld power tool 40 in a quick, simple, rigid, and reliable manner. That is, in a fastening procedure of the attachment device 10 to an elongated portion 33′ of the handheld power tool 40, the user may remove the fastening element 7 indicated in FIG. 3 and may pivot the fastening member 6 around the third pivot axis ax3 to a position allowing the fastening section 5 to be placed against the elongated portion 33 of the handheld power tool 40. Then, the user may pivot the fastening member 6 in an opposite pivoting direction around the third pivot axis ax3 to a position in which the second end 6″ of the fastening member 6 can be attached to the device body 3 using the fastening element 7. The fastening section 5 and the fastening member 6 are configured to apply clamping forces onto the elongated portion 33′ of the handheld power tool 40 in directions substantially perpendicular to the direction of elongation de of the elongated portion 33′ of the handheld power tool 40 when the fastening element 7 is tightened.

According to the illustrated embodiments, the fastening member 6 is bracket-like and is formed by a metal-material. Moreover, according to the illustrated embodiments, the device body 3 is formed by a polymeric material. Purely as examples, the device body 3 may be formed by nylon, such as PA 6, a fibre-reinforced plastic, such as fibreglass, or a mixture thereof. In embodiments in which the device body 3 is formed by a polymeric material, a light-weighted attachment device 10 can be obtained while ensuring a strong and rigid attachment device 10. The device body 3 may comprise threads engaging with threads of the fastening element 7.

FIG. 4 illustrates a second enlarged view of the handle assembly 31 of the handheld power tool 40 illustrated in FIG. 1. In FIG. 4, the attachment loop 1 has been pivoted around the first pivot axis ax1 from the storage position illustrated in FIG. 2 to a use position. As can be seen when comparing FIG. 2 and FIG. 4, the attachment loop 1 protrudes further out from the device body 3, and thus also from the elongated portion 33′of the handheld power tool 40, when the attachment loop 1 is in the use position as compared to when the attachment loop 1 is in the storage position.

The use position allows a user to thread the attachment loop 1 over a hook of a user worn appliance in a quick, simple, and convenient manner as is further explained herein. Moreover, by pivoting the attachment loop 1 to the storage position illustrated in FIG. 2, a more compact attachment device 10 is provided reducing the risk of the attachment loop 1 becoming stuck in objects, such as tree branches, and the like.

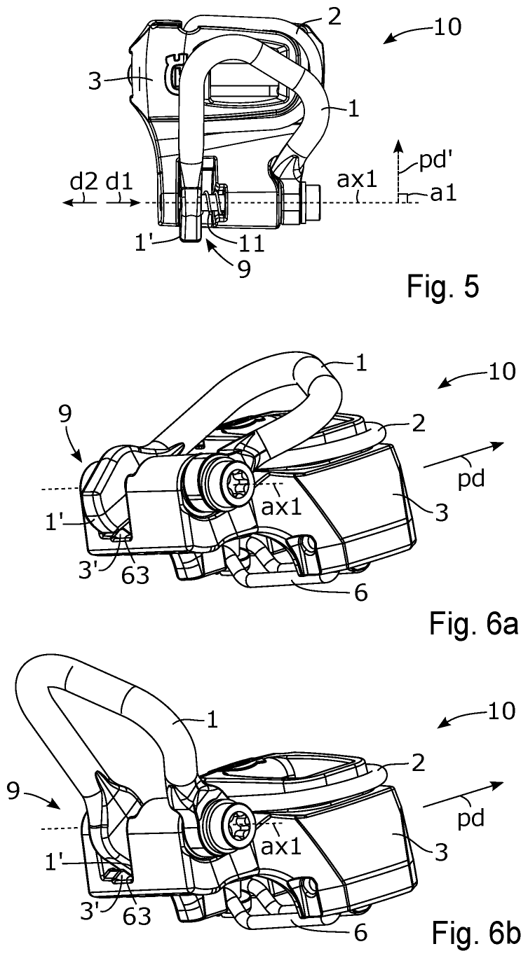

FIG. 5 illustrates a first front view of the attachment device 10 illustrated in FIG. 3. In FIG. 5, the attachment device 10 is illustrated as seen from an opposite side of the attachment device 10 as compared to in FIG. 3. In FIG. 5, as well as in FIG. 3, the attachment loop 1 is illustrated in the storage position.

As is indicated in FIG. 5, the attachment device 10 comprises a locking arrangement 9. The locking arrangement 9 is configured to lock the attachment loop 1 from pivoting from the storage position when the attachment loop 1 is in the storage position and the locking arrangement 9 is in a locking state. Moreover, as is explained in the following, the locking arrangement 9 is configured to assume a locking state when the attachment loop 1 is pivoted to the storage position.

FIG. 6a illustrates a perspective view of the attachment device 10 illustrated in FIG. 5. As is seen in FIG. 6a, a portion 1′ of the attachment loop 1 forms part of the locking arrangement 9. Moreover, in more detail, according to the illustrated embodiments, the locking arrangement 9 comprises a protrusion 3′ arranged on the device body 3. According to these embodiments, the locking arrangement 9 is configured to lock the attachment loop 1 from pivoting around the first pivot axis ax1 by an abutting contact between the portion 1′ of the attachment loop 1 and the protrusion 3′ when the locking arrangement 9 is in a locking state.

As is explained in the following, according to the illustrated embodiments, the locking arrangement 9 is configured to be transferred from a locking state to an unlocking state by elastic deformation of the attachment loop 1. The following is explained with simultaneous reference to FIG. 5 and FIG. 6a. The attachment loop 1 is provided with an elasticity allowing a user to move the portion 1′of the attachment loop 1 along a first direction d1 at least substantially coinciding with the first pivot axis ax1 by compressing portions of the attachment loop 1 using the fingers of one hand.

The user may move the portion 1′ of the attachment loop 1 along the first direction d1 by compressing a first and a second end portion of the attachment loop 1 in directions at least substantially coinciding with the first pivot axis ax1, wherein each of the first and second end portions of the attachment loop 1 is pivotally arranged to the device body 3 around the first pivot axis ax1.

As seen in FIG. 6a, the device body 3 comprises a space 63 located adjacent to the protrusion 3′ as seen in a direction parallel to the first pivot axis ax1. The portion 1′ of the attachment loop 1 is allowed to move inside the space 63 when the portion 1′ of the attachment loop 1 has been moved in the first direction d1 to an unlocking position. In this manner, the attachment loop 1 is allowed to be pivoted from the storage position illustrated in FIG. 5 and FIG. 6a when the portion 1′ of the attachment loop 1 has been moved in the first direction d1 to the unlocking position.

As understood from the above, the locking arrangement 9 is transferred from a locking state to an unlocking state when the portion 1′ of the attachment loop 1 has been moved in the first direction d1 to the unlocking position. In other words, according to the illustrated embodiments, the portion 1′ of the attachment loop 1 is configured to move along a first direction d1 at least substantially coinciding with the first pivot axis ax1 when the locking arrangement 9 is transferred from a locking state to an unlocking state.

FIG. 6b illustrates the perspective view of the attachment device 10 illustrated in FIG. 6b in which the attachment loop 1 has been pivoted around the first pivot axis ax1 to the use position.

Below, simultaneous reference is made to FIG. 5-FIG. 6b, if not indicated otherwise. As mentioned, according to the illustrated embodiments, the attachment loop 1 is provided with some elasticity. The elasticity of the attachment loop 1 causes a movement of the portion 1′ of the attachment loop 1 in a second direction d2, being opposite to the first direction d1, to a locking position when the attachment loop 1 reaches the use position. In FIG. 6b, the portion 1′ of the attachment loop 1 is illustrated in the locking position. In this manner the locking arrangement 9 assumes a locking state when the attachment loop 1 is pivoted to the use position.

Moreover, according to the illustrated embodiments, the attachment device 10 comprises a resilient element 11 configured to bias the portion 1′ of the attachment loop 1 in the second direction d2. In this manner, it can be further ensured that the locking arrangement 9 assumes a locking position when the attachment loop 1 is pivoted to one of the use position and the storage position as is further explained herein. According to the illustrated embodiments, the resilient element 11 is a coil spring concentrically arranged around the first pivot axis ax1. According to further embodiments, the attachment device 10 may comprise another type of resilient element configured to bias the portion 1′ of the attachment loop 1 in the second direction d2.

As can be seen in FIG. 6b, the locking arrangement 9 is configured to lock the attachment loop 1 from pivoting from the use position when the attachment loop 1 is in the use position and the locking arrangement 9 is in a locking state. According to the illustrated embodiments, this is obtained by an abutting contact between the portion 1′ of the attachment loop 1 and the protrusion 3′ arranged on the device body 3.

Again, if a user wants to pivot the attachment loop 1 from the use position illustrated in FIG. 6b to the storage position illustrated in FIG. 5 and FIG. 6a, the user may move the portion 1′ of the attachment loop 1 along the first direction d1 by compressing the first and second end portions of the attachment loop 1 in directions at least substantially coinciding with the first pivot axis ax1 until the portion 1′ of the attachment loop 1 reaches an unlocking position in which the portion 1′ of the attachment loop 1 is free to move inside the space 63. Accordingly, the user may then pivot the attachment loop 1 to the storage position illustrated in FIG. 5 and FIG. 6a.

When the attachment loop 1 reaches the storage position, the portion 1′ of the attachment loop 1 moves to a locking position by the elasticity of the attachment loop 1 and the biasing force of the resilient element 11. In this manner, the locking arrangement 9 assumes a locking state when the attachment loop 1 is pivoted to the storage position. As understood from the above, according to the illustrated embodiments, the elasticity of the attachment loop 1 biases the portion 1′ of the attachment loop 1 in the second direction d2 when the portion 1′ has been moved in the first direction d1 to an unlocking position.

According to the illustrated embodiments, the attachment loop 1 is formed by a polymeric material. Purely as examples, the attachment loop 1 may be formed by nylon, such as PA 6, a fibre-reinforced plastic, such as fibreglass, or a mixture thereof. Moreover, the attachment loop 1 may comprise a metal wire, such as a steel wire, embedded in a polymeric material. Furthermore, the attachment loop 1 may comprise one or more metal bushings, such as one or more steel bushings, wherein the attachment loop 1 is pivotally arranged on the device body 3 around the first pivot axis ax1 between a storage position and use position via the one or more metal bushings.

According to the illustrated embodiments, the smallest diameter of the attachment loop 1 is approximately 5 mm. according to further embodiments, the smallest diameter of the attachment loop 1 may be greater than 5 mm, and/or may be within the range of 5-10 mm.

FIG. 7a illustrates a second front view of the attachment device 10 illustrated in FIG. 3. In FIG. 7a, the attachment loop 1 is illustrated in the use position. As can be clearly seen in FIG. 7a, according to the illustrated embodiments, the attachment device 10 comprises a second loop 2. The second loop 2 is also indicated in FIG. 2, FIG. 4, FIG. 5, FIG. 6a, and FIG. 6b. As is further explained herein, the second loop 2 can be used to secure a handheld power tool to a user worn appliance using a lanyard, a cord, a rope, or the like, extending between the user worn appliance and the second loop 2.

Below, simultaneous reference is made to FIG. 1-FIG. 7a, if not indicated otherwise. The second loop 2 pivotally arranged on the device body 3 around a second pivot axis ax2 between a storage position and at least one use position. Moreover, as is further explained below, according to the illustrated embodiments, the second loop 2 is pivotally arranged between two different use positions. In FIG. 7a, the second loop 2 is illustrated in the storage position and the attachment loop 1 is illustrated in the use position.

As seen in FIG. 7a, the second pivot axis ax2 is transversal to the first pivot axis ax1. In more detail, according to the illustrated embodiments, the angle between the first and second pivot axes ax1, ax2 is approximately 90 degrees. According to further embodiments, the angle between the first and second pivot axes ax1, ax2 may be within the range of 20-160 degrees or may be within the range of 80-100 degrees.

Moreover, according to the illustrated embodiments, the second loop 2 is formed by a metal material. Furthermore, according to the illustrated embodiments, the diameter of the second loop 2 is approximately 3 mm. According to further embodiments, the diameter of the second loop 2 may be within the range of 1.5-5 mm, or may be within the range of 2-4 mm.

FIG. 7b illustrates the attachment device 10 illustrated in FIG. 7a in which the second loop 2 has been pivoted to a first use position. According to the illustrated embodiments, the angle between the storage position and the first use position is approximately 90 degrees. According to further embodiments, the angle between the storage position and the first use position may be within the range of 70-110 degrees or may be within the range of 80-100 degrees.

A user may want to pivot the second loop 2 to the first use position when wanting to secure a handheld power tool to a user worn appliance using a lanyard, a cord, a rope, or the like, extending between the user worn appliance and the second loop 2.

FIG. 7c illustrates the attachment device 10 illustrated in FIG. 7b in which the second loop 2 has been pivoted to a second use position. According to the illustrated embodiments, the angle between the first and second use positions is approximately 90 degrees. According to further embodiments, the angle between the first and second use positions may be within the range of 70-110 degrees or may be within the range of 80-100 degrees. In other words, according to the illustrated embodiments, the angle between the storage position illustrated in FIG. 7a and the second use position illustrated in FIG. 7c is approximately 180 degrees. In FIG. 7b and FIG. 7c, the attachment loop 1 is illustrated in the use position.

FIG. 7d illustrates the attachment device 10 illustrated in FIG. 7c in which the attachment loop 1 has been pivoted to the storage position. A user may want to pivot the second loop 2 to the second use position and the attachment loop 1 to the storage position when wanting to secure a handheld power tool to a user worn appliance using a lanyard, a cord, a rope, or the like, extending between the user worn appliance and the second loop 2 and when not wanting to attach the attachment loop 1 to a hook of the user worn appliance.

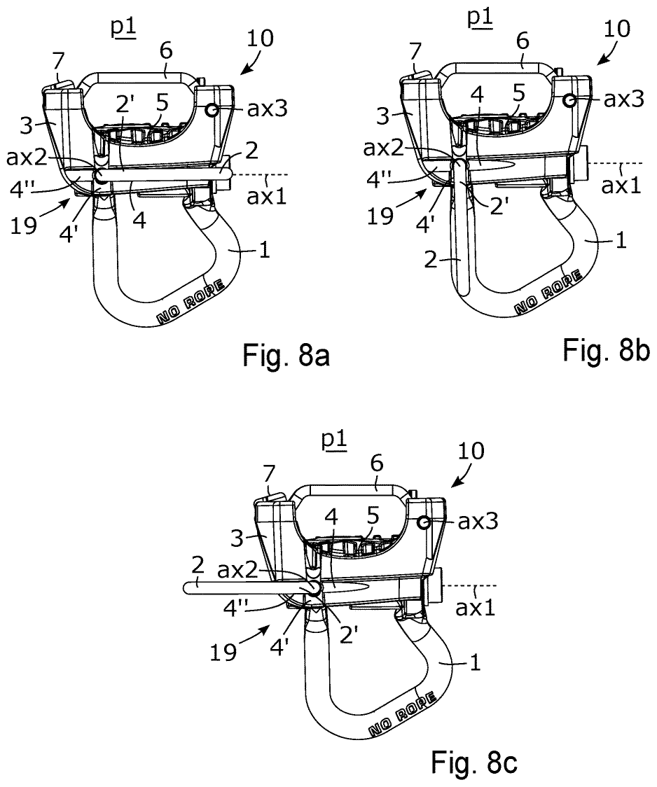

FIG. 8a illustrates a top view of the attachment device 10 illustrated in FIG. 7a. In FIG. 8a, the attachment device 10 is illustrated as seen in a direction perpendicular to the plane p1 indicated in FIG. 2 and FIG. 4. In other words, in FIG. 8a, the attachment device 10 is illustrated as seen in a direction coinciding with the predetermined direction pd indicated in FIG. 2, FIG. 3, FIG. 4, FIG. 6a, and FIG. 6b. Like in FIG. 7a, the attachment loop 1 is illustrated in the use position and the second loop 2 is illustrated in the storage position in FIG. 8a.

As is indicated in FIG. 8a, according to the illustrated embodiments, the attachment device 10 comprises a snap fit assembly 19. As is further explained below, the snap fit assembly 19 is configured to releasably retain the second loop 2 in the storage position and in the first and second use positions. In embodiments in which the second loop 2 of the attachment device 10 comprises one use position only, the snap fit assembly 19 may be configured to releasably retain the second loop 2 in such a use position.

As can be seen in FIG. 8a, according to the illustrated embodiments, the snap fit assembly 19 is formed by a number of grooves 4, 4′, 4″ on the device body 3 and a portion 2′ of the second loop 2. Each of the number of grooves 4, 4′, 4″ has a radius of curvature substantially corresponding to the radius of the second loop 2. That is, in more detail, each of the number of grooves 4, 4′, 4″ has an inner radius of curvature substantially corresponding to an outer radius of the portion 2′ of the second loop 2.

The number of grooves 4, 4′, 4″ of the snap fit assembly 19 comprises a first groove 4, wherein the portion 2′ of the second loop 2 protrudes into the first groove 4 when the second loop 2 is in the storage position. In this manner, the second loop 2 is releasably retained in the storage position.

As is best seen in FIG. 7a, according to the illustrated embodiments, the second loop 2 is C-shaped. Moreover, the second loop 2 comprises a first end portion and a second end portion. The first and second end portions are provided at a respective end of the C-shape of the second loop 2. According to the illustrated embodiments, the second loop 2 is pivotally arranged around the second pivot axis ax1 via each of the first and second end portions. Moreover, each of the first and second end portions protrudes into an aperture in the device body 3 of the attachment device 10. The dimensions and material of the second loop 2 are adapted such that the second loop 2 is provided with some flexibility such that the first and second end portions of the second loop 2 can be moved slightly in directions away from each other, i.e., in directions coinciding with the second pivot axis ax2.

In this manner, a user can release the second loop 2 from the storage position by applying a force onto the second loop 2 causing a pivoting movement of the second loop 2 from the storage position towards the first use position. That is, when the user applies such a force onto the second loop 2, the potion 2′ of the second loop 2 is moved out of the first groove 4 to allow a pivoting of the second loop 2 from the storage position to the first use position.

The dimensions and material of the second loop 2 are adapted such that the flexibility of the second loop 2 ensures that some predetermined force is needed to be applied onto the second loop 2 for pivoting the second loop 2 from the storage position.

FIG. 8b illustrates the top view of the attachment device 10 illustrated in 8a in which the second loop 2 has been pivoted to the first use position. In FIG. 8b, the attachment loop 1 is illustrated in the use position. The positions of the attachment loop 1 and the second loop 2 thus corresponds to the positions of the attachment loop 1 and the second loop 2 illustrated in FIG. 7b. Below, simultaneous reference is made to FIG. 1-FIG. 8b, if not indicated otherwise.

In FIG. 8b, the first groove 4 provided on the device body 3 of the attachment device 10 can be more clearly seen. As indicated in FIG. 8a and FIG. 8b, the number of grooves 4, 4′, 4″ of the snap fit assembly 19 comprises a second groove 4′. As can be seen in FIG. 8b, the portion 2′ of the second loop 2 protrudes into the second groove 4′ when the second loop 2 is in the first use position. In this manner, the second loop 2 is releasably retained in the first use position. The portion 2′ of the second loop 2 is configured to move into the second groove 4′ by the flexibility/elasticity of the second loop 2. That is, when the second loop 2 reaches the first use position, the first and second end portions of the second loop 2 moves in a direction towards each other along directions coinciding with the second pivot axis ax2 such that the portion 2′ of the second loop 2 can be moved into the first groove 4 to releasably retain the second loop 2 in the first use position.

The second loop 2 can be pivoted from the first use position in the same manner as described above for the movement of the second loop 2 from the storage position.

FIG. 8c illustrates the top view of the attachment device 10 illustrated in 8b in which the second loop 2 has been pivoted to the second use position. In FIG. 8c, the attachment loop 1 is illustrated in the use position. The positions of the attachment loop 1 and the second loop 2 thus corresponds to the positions of the attachment loop 1 and the second loop 2 illustrated in FIG. 7c. Below, simultaneous reference is made to FIG. 1-FIG. 8c, if not indicated otherwise.

As indicated in FIG. 8a-FIG. 8c, the number of grooves 4, 4′, 4″ of the snap fit assembly 19 comprises a third groove 4″. As can be seen in FIG. 8c, the portion 2′ of the second loop 2 protrudes into the second groove 4′ when the second loop 2 is in the second use position. In this manner, the second loop 2 is releasably retained in the second use position. The portion 2′ of the second loop 2 is configured to move into the third groove 4″ by the flexibility/elasticity of the second loop 2. That is, when the second loop 2 reaches the second use position, the first and second end portions of the second loop 2 moves in a direction towards each other along directions coinciding with the second pivot axis ax2 such that the portion 2′ of the second loop 2 can be moved into the third groove 4″ to releasably retain the second loop 2 in the second use position.

The second loop 2 can be pivoted from the second use position by applying a force onto the second loop 2 in a direction from the second use position towards the first use position. If so, the second loop 2 will flex to allow a movement of the respective first and second end portions in a direction away from each other according to the above to allow the second loop 2 to be pivoted from the second use position towards the first use position.

Likewise, the second loop 2 can be pivoted from the first use position to the storage position by applying a force onto the second loop 2 in a direction from the first use position towards the storage position. If so, the second loop 2 will flex to allow a movement of the respective first and second end portions in a direction away from each other according to the above to allow the second loop 2 to be pivoted from the first use position towards the storage position. When the second loop 2 reaches the storage position, the first and second end portions of the second loop 2 moves in a direction towards each other along directions coinciding with the second pivot axis ax2 such that the portion 2′ of the second loop 2 can be moved into the first groove 4 to releasably retain the second loop 2 in the storage position.

In FIG. 8a-FIG. 8c, the third pivot axis ax3 of the fastening member 6 is indicated. According to the illustrated embodiments, the second and third pivot axes ax2, ax3 are parallel to each other. According to further embodiments, the second and third pivot axes ax2, ax3 may be angled relative to each other, for example with an angle less than 45 degrees, or less than 25 degrees. In FIG. 8a-FIG. 8c, the attachment device 10 is illustrated as viewed in a direction coinciding with each of the second and third pivot axes ax2, ax3.

Moreover, in FIG. 8a-FIG. 8c, the shape of the fastening section 5 of the attachment device 10 can be clearly seen. According to the illustrated embodiments, the fastening section 5 is curve-shaped with an inner radius of curvature substantially corresponding to an outer radius of curvature of the elongated portion 33′ of the handheld power tool 40.

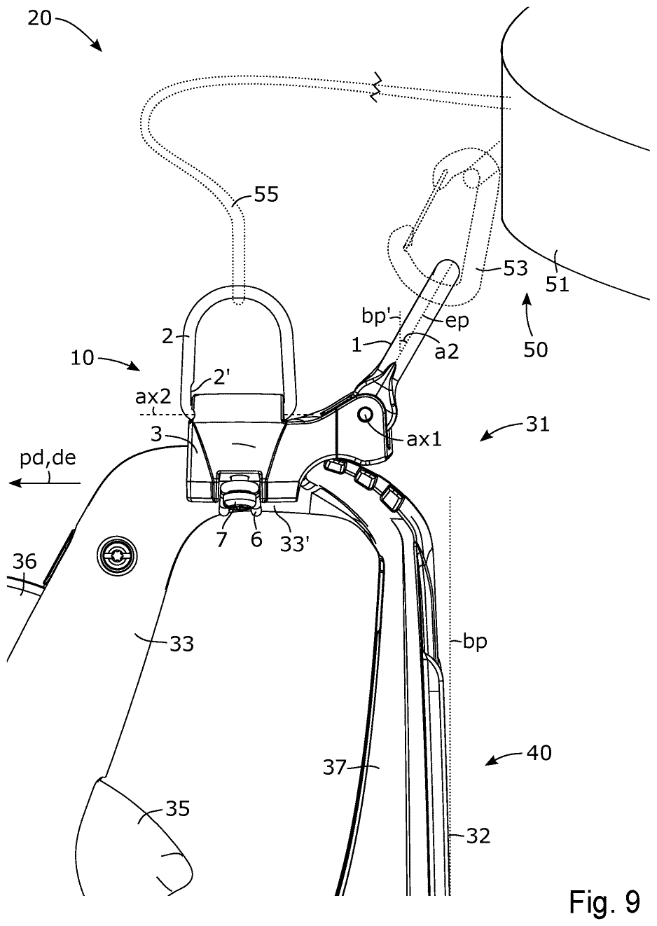

FIG. 9 illustrates a handheld power tool 40 according to the embodiments illustrated in FIG. 1, wherein the handheld power tool 40 is attached to a user worn appliance 50 using an attachment device 10 as explained with reference to FIG. 2-FIG. 8c. Below, simultaneous reference is made to FIG. 1-FIG. 9, if not indicated otherwise.

In FIG. 9, the attachment device 10 is fastened to the elongated portion 33′ of the handheld power tool 40 in the same manner as explained with reference to FIG. 2 above. Moreover, in FIG. 9, the attachment loop 1 is illustrated in the use position and the second loop 2 is illustrated in the first use position.

In FIG. 9, the user worn appliance 50 is schematically illustrated as a belt 51 comprising a hook 53 and a lanyard 55 each attached to the belt 51. According to further embodiments, the user worn appliance 50 may be formed as a harness, or the like. As seen in FIG. 9, the handheld power tool 40 is attached to the belt 51 of the user worn appliance 50 by the hook 53 protruding into the attachment loop 1 of the attachment device 10. Moreover, the handheld power tool 40 is further secured to the belt 51 of the user worn appliance 50 by the lanyard 55 being attached to the second loop 2 of the attachment device 10.

In this manner, the use of the handheld power tool 40 at high locations, such as when a user is high up in a tree, or on a ladder, is significantly facilitated. This is because the user can unhook the attachment loop 1 from the hook 53 in a simple and convenient manner using one hand only while the handheld power tool 40 is secured to the user via the lanyard 55 connected to the second loop 2. In this manner, the handheld power tool 40 is secured relative to the user in case the user drops the handheld power tool 40. Moreover, the attachment device 10 allows the user to attach the handheld power tool 40 to the belt 51 of the user worn appliance 50 in a simple and convenient manner using one hand only by threading the attachment loop 1 over the hook 53 of the user worn appliance 50.

In FIG. 9, a bottom plane bp of the handheld power tool 40 is indicated. The bottom plane bp of the handheld power tool 40 is parallel to a flat horizontal support surface Hs when the handheld power tool 40 is positioned in the usual upright parking position on the flat horizontal support surface Hs. According to the illustrated embodiments, the bottom plane bp of the handheld power tool 40 is formed by the bottom side 32 of the handheld power tool 40. The bottom side 32 of the handheld power tool 40 and the flat horizontal support surface Hs are explained e.g., with reference to FIG. 1 above. The bottom side 32 of the handheld power tool 40 may also be referred to as a bottom surface of the handheld power tool 40.

In FIG. 9, an extension plane ep of the attachment loop 1 is indicated. The attachment loop 1 extends in the extension plane ep. Moreover, the attachment loop 1 is loop-shaped, i.e., curve-shaped, in the extension plane ep of the attachment loop 1.

According to the illustrated embodiments, the angle a2 between the extension plane ep of the attachment loop 1 and the bottom plane bp of the handheld power tool 40 is approximately 30 degrees when the attachment loop 1 is in the use position and the attachment device 10 is attached to the elongated portion 33′ of the handheld power tool 40 such that the predetermined direction pd of the attachment device 10 coincides with the direction of elongation de of the elongated portion 33′ of the handheld power tool 40. According to further embodiments, the angle a2 between the extension plane ep of the attachment loop 1 and the bottom plane bp of the handheld power tool 40 may be within the range of 0 -60 degrees, or may be within the range of 15-45 degrees, when the attachment loop 1 is in the use position and the attachment device 10 is attached to the elongated portion 33′ of the handheld power tool 40 such that the predetermined direction pd of the attachment device 10 coincides with the direction of elongation de of the elongated portion 33′ of the handheld power tool 40.

In this manner, it can be ensured that the handheld power tool 40 hangs in a predetermined, safe, and convenient orientation relative to the user from a hook 53 of a user worn appliance 50 when the attachment loop 1 of the attachment device 10 is threaded over the hook 53. Moreover, it can be ensured that the handheld power tool 40 can be attached to the hook 53, and detached from the hook 53, in a simple and convenient manner, using one hand only.

In FIG. 9, the angle a2 is indicated between the extension plane ep of the attachment loop 1 and a plane bp′. The plane bp′ in FIG. 9 is parallel to the bottom plane bp of the handheld power tool 40.

As can be seen in FIG. 7a, FIG. 7b, FIG. 7c, FIG. 8a, FIG. 8b, and FIG. 8c, according to the illustrated embodiments, the attachment loop 1 is provided with the text “NO ROPE”. This indicates for a user that the attachment loop 1 is intended to be used to attach a handheld power tool 40 to a user worn appliance 50 by being threaded over a hook 53 of the user worn appliance 50 instead of being used for further securing the handheld power tool 40 relative to the user worn appliance 50 using a lanyard 55, a cord, a rope, or the like. Instead, as explained herein, the second loop 2 of the attachment device 10 is provided for this purpose.

The attachment device 10 according to embodiments herein may be sold as a separate unit as an accessory for handheld power tools for facilitating attachment of the handheld power tool to a user worn appliance.

As an alternative, or in addition the attachment device 10 according to embodiments herein, may be included in a kit 20 comprising a handheld power tool 40 and the attachment device 10, wherein the attachment device 10 is attachable to an elongated portion 33′of the handheld power tool 40 such that a predetermined direction pd of the attachment device 10 coincides with a direction of elongation de of the elongated portion 33′ of the handheld power tool 40. The reference sign “20” indicating such a kit 20 is provided in FIG. 2, FIG. 4, and FIG. 9.

According to some embodiments, the kit 20 comprises the user worn appliance 50, wherein the user worn appliance 50 comprises a belt 51 or a harness provided with a hook 53, and wherein the attachment loop 1 of the attachment device 10 is attachable to the hook 53 when the attachment loop 1 is in the use position.

Since the attachment device 10 is removable from the elongated portion 33′ of the handheld power tool 40, the attachment device 10 can be replaced in a simple manner if the attachment device 10 becomes damaged or worn.

The wording “substantially parallel to”, as used herein, may encompass that the angle between the objects referred to is less than 10 degrees, or is less than 7 degrees.

The wording “substantially coinciding with”, as used herein, may encompass that the angle between the objects referred to is less than 10 degrees, or is less than 7 degrees.

The wording “substantially perpendicular to”, as used herein, may encompass that the angle between the objects or vectors referred to is within the range of 80-100 degrees or is within the range of 83-97 degrees.

The wording “substantially corresponding to”, as used herein, may encompass that the forms or shapes referred to deviates less than 10% from each other.

The wording “approximately” as used herein may be interpreted as that the aspect, distance, angle, measurement, or the like, deviates less than 5% from the given value/number, or deviates less than 5 degrees from the given angle.

The user worn appliance 50, as referred to herein, may also be referred to as a user worn accessory, a user worn belt, or a user worn harness.

The storage position of the attachment loop 1, as referred to herein, may also be referred to as a “no-use position”. Likewise, the storage position of the second loop 2, as referred to herein, may also be referred to as a “no-use position”.

Furthermore, the attachment loop 1, as referred to herein, may also be referred to as “a first attachment loop”. Likewise, the second loop 2, as referred to herein, may also be referred to as “a second attachment loop”, “a securing loop”, “a fastening loop”, or the like.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

As used herein, the term “comprising” or “comprises” is open-ended, and includes one or more stated features, elements, steps, components, or functions but does not preclude the presence or addition of one or more other features, elements, steps, components, functions, or groups thereof.

1. An attachment device configured to be fastened to a handheld power tool for facilitating attachment of the handheld power tool to a user worn appliance, wherein the device comprises:
a device body comprising a fastening section configured to be fastened against an elongated portion of the handheld power tool such that a predetermined direction of the device coincides with a direction of elongation of the elongated portion of the handheld power tool, and
an attachment loop pivotally arranged on the device body around a first pivot axis between a storage position and use position,
and wherein an angle between the first pivot axis and the predetermined direction is within the range of 70-110 degrees.

2. The device according to claim 1, wherein the device comprises a fastening member arranged on the device body, and wherein the fastening section and the fastening member together are configured to enclose the elongated portion of the handheld power tool.

3. The device according to claim 2, wherein a first end of the fastening member is pivotally arranged on the device body-(3), and wherein a second end of the fastening member is configured to be attached to the device body using a fastening element, and
wherein the fastening section and the fastening member together are configured to enclose the elongated portion of the handheld power tool in a plane perpendicular to the direction of elongation of the elongated portion of the handheld power tool or wherein the fastening section and the fastening member are configured to apply clamping forces onto the elongated portion of the handheld power tool in directions substantially perpendicular to the direction of elongation of the elongated portion of the handheld power tool.

4. (canceled)

5. (canceled)

6. The device according to claim 1, wherein the device comprises a locking arrangement configured to lock the attachment loop from pivoting from the storage position when the attachment loop is in the storage position and the locking arrangement is in a locking state, and
wherein the locking arrangement is configured to assume a locking state when the attachment loop is pivoted to the storage position.

7. (canceled)

8. The device according to claim 1, wherein the device comprises a locking arrangement configured to lock the attachment loop from pivoting from the use position when the attachment loop is in the use position and the locking arrangement is in a locking state.

9. The device according to claim 8, wherein the locking arrangement is configured to assume a locking state when the attachment loop is pivoted to the use position.

10. The device according to claim 6, wherein a portion of the attachment loop forms part of the locking arrangement,
wherein the locking arrangement comprises a protrusion arranged on the device body, and wherein the locking arrangement is configured to lock the attachment loop from pivoting around the first pivot axis by an abutting contact between a portion of the attachment loop and the protrusion when the locking arrangement is in a locking state, or
wherein the locking arrangement is configured to be transferred from a locking state to an unlocking state by elastic deformation of the attachment loop.

11. (canceled)

12. The device according claim 10, wherein the portion of the attachment loop is configured to move along a first direction at least substantially coinciding with the first pivot axis when the locking arrangement is transferred from a locking state to an unlocking state, or wherein the device comprises a resilient element configured to bias the portion of the attachment loop in a second direction being opposite to the first direction.

13. (canceled)

14. (canceled)

15. The device according to claim 1, wherein the attachment loop is formed by a polymeric material, or wherein a smallest diameter of the attachment loop is greater than 5 mm.

16. (canceled)

17. The device according to claim 1, wherein the device comprises a second loop pivotally arranged on the device body around a second pivot axis between a storage position and at least one use position.

18. The device according to claim 17, wherein the second pivot axis is transversal to the first pivot axis,
wherein the second loop is formed by a metal material, or
wherein the diameter of the second loop is within a range of 1.5-5 mm.

19. The device according to claim 17, wherein an angle between the first and second pivot axes is within a range of 20-160 degrees.

20. (canceled)

21. (canceled)

22. The device according to claim 17, wherein the second loop is pivotally arranged on the device body between the storage position and a first and a second use position.

23. The device according to claim 22, wherein sn angle between the first and second use positions is within the range of 70-110 degrees, or
wherein an angle between the storage position and the first use position is within the range of 70-110 degrees.

24. (canceled)

25. The device according to claim 17, wherein the device comprises a snap fit assembly configured to releasably retain the second loop in the storage position and the at least one use position, and
wherein the snap fit assembly is formed by a number of grooves on the device body and a portion of the second loop.

26. (canceled)

27. A kit comprising a handheld power tool and an attachment device according to claim 1, wherein the device is attachable to an elongated portion of the handheld power tool such that a predetermined direction of the device coincides with a direction of elongation of the elongated portion of the handheld power tool.

28. The kit according to claim 27, wherein the elongated portion of the handheld power tool is a handle portion of the handheld power tool.

29. The kit according to claim 27, wherein the attachment loop is loop-shaped in an extension plane of the attachment loop, and wherein the angle between the extension plane of the attachment loop and a bottom plane of the handheld power tool is within the range of 0 -60 degrees, when the attachment loop is in the use position and the device is attached to the elongated portion of the handheld power tool such that the predetermined direction of the device coincides with the direction of elongation of the elongated portion of the handheld power tool.

30. The kit according to claim 27, wherein the handheld power tool is a chainsaw or a hedge trimmer.

31. A handheld power tool comprising the attachment device according claim 1, wherein the device is attached to an elongated portion of the handheld power tool such that a predetermined direction of the device coincides with a direction of elongation of the elongated portion of the handheld power tool.
